(19) United States
(12) Patent Application Publication
(10) Pub. No.: US 2024/0027097 A1
(43) Pub. Date: Jan. 25, 2024

(54) HEATER TANK

(71) Applicant: KOHLER MIRA LIMITED, Cheltenham (GB)

(72) Inventors: Kevin Peel, Cheltenham (GB); Craig Fitton, Cheltenham (GB)

(21) Appl. No.: 18/350,868

(22) Filed: Jul. 12, 2023

(30) Foreign Application Priority Data
Jul. 19, 2022 (GB) 2210585.2

(51) Int. Cl. F24H 1/10; F24H 1/14

(52) U.S. Cl. CPC F24H 1/101; F24H 1/142

(57) ABSTRACT

A heater tank for an instantaneous water heater is provided, comprising a heater tank having a heater tank inlet, a heater tank outlet, and a fluid flow path from the heater tank inlet to the heater tank outlet. One or more electric heating elements have an electric heating element power and are operable to heat fluid flowing, in use, along the fluid flow path. One or more of the electric heating elements extend along at least a portion of the fluid flow path and are configured such that the fluid flowing, in use, along the fluid flow path experiences a reduction in a local electric heating element power as the fluid flows, in use, along the fluid flow path.

### CROSS REFERENCE

This application claims priority to UK Application No. GB2210406.1, filed 15 Jul. 2022, the entirety of which is hereby incorporated by reference.

### FIELD OF THE INVENTION

This disclosure relates to a heater tank for an instantaneous water heater for use in a plumbing system such as an ablutionary system or a heating system. The disclosure also relates to plumbing systems, including ablutionary systems or heating systems, comprising such a heater tank for an instantaneous water heater.

### BACKGROUND

An electric shower system is an example of an ablutionary system. An electric shower system typically includes a wall-mounted unit containing an instantaneous water heater. The instantaneous water heater comprises a heating chamber containing one or more heating elements operable to heat water passing through the heating chamber. An inlet communicating with the heating chamber is connected to a cold water supply. A shower head is provided in fluid communication with an outlet from the heating chamber.

### BRIEF DESCRIPTION OF THE DRAWINGS

Examples are described below with reference to the accompanying drawings, in which:

FIG. 1 shows a sectional view of a portion of a heater tank.

FIG. 2 shows a sectional view of a heater tank for an instantaneous water heater.

FIG. 3 shows a cross-sectional view through a first heater tube of a heater tank.

FIG. 4 shows example electric heating power values for an electric heating elements in a heater tank.

FIG. 5 shows a computational fluid dynamics heat map representation of electric heating elements disposed within a heater tank.

FIG. 6 shows a comparative computational fluid dynamics heat map representation of electric heating elements disposed within a known heater tank for an instantaneous water heater.

FIG. 7 shows a sectional view of an example of a heater tank for an instantaneous water heater.

FIG. 8 shows a sectional view of a portion of a heater tank.

FIG. 9 shows example power values for electric heating elements of a heater.

FIG. 10 is a graph showing results of a hot shot test for a known heater tank for an instantaneous water heater.

FIG. 11 is a graph showing results of a hot shot test for an example heater tank.

FIG. 12 shows schematically an electric shower system.

### DETAILED DESCRIPTION OF THE DRAWINGS

Some instantaneous water heaters may be susceptible to limescale build up, particularly on surfaces of the heating elements, which can lead to a decrease in performance.

Some instantaneous water heaters may also be susceptible to “hot shot”. Hot shot is the result of an abrupt stopping and restarting of a flow of water from an instantaneous water heater. If a flow of water from an instantaneous water heater is stopped then non-flowing water within the heating chamber may be further heated due to residual heat from the heating element(s) to an elevated temperature that could be unsafe for a user. If a flow of water is then quickly allowed to flow from the water heater then restarts after only a relatively short delay, then the flow of water may be at the elevated temperature.

A first aspect provides a heater tank for an instantaneous water heater comprising a heater tank having a heater tank inlet and a heater tank outlet and a fluid flow path from the heater tank inlet to the heater tank outlet; one or more electric heating elements having an electric heating element power and operable to heat fluid flowing, in use, along the fluid flow path; wherein one or more of the electric heating elements extend along at least a portion of the fluid flow path and are configured such that the fluid flowing, in use, along the fluid flow path experiences a reduction in a local electric heating element power as the fluid flows, in use, along the fluid flow path.

The local electric heating element power may be understood as the heating power at a given point on a given electric heating element.

The electric heating element power for a given electric heating element may be understood as the overall heating power of the given electric heating element considered as a whole. The sum or integral of the local electric heating element powers across a given electric heating element constitutes the electric heating element power for the given electric heating element.

As a result of the fluid flowing, in use, along the fluid flow path experiencing a reduction in the local electric heating element power as the fluid flows, in use, along the fluid flow path, a maximum surface temperature of the electric heating element(s) may be reduced and/or an average surface temperature of the electric heating element(s) may be reduced. Consequently, the heater tank may be less susceptible to limescale build-up and/or any hot shot after an interruption of flow may be relatively less noticeable and/or uncomfortable and/or dangerous for a user.

The reduction in the local electric heating element power experienced by the fluid flowing, in use, along the fluid flow path may be effected in any suitable way or combination of ways.

For example, the fluid flow path may bring fluid into contact with a series of two of more electric heating elements, in which at least one of the electric heating elements has an electric heating element power that is less than that of the electric heating element immediately upstream thereof.

Additionally or alternatively, one or more of the electric heating elements may comprise a series of a plurality of electric heating element segments, wherein at least one of the electric heating element segments has an electric heating element segment power that is less than that of the electric heating element segment immediately upstream thereof.

For example, one or more of the electric heating elements may comprise a series of up to or at least five electric heating element segments, up to or at least 10 electric heating element segments, up to or at least 20 electric heating element segments or up to or at least 50 electric heating element segments.

The sum of the electric heating element segment powers within a given electric heating element may constitute the electric heating element power.

Additionally or alternatively, one or more of the electric heater elements may be configured such that the local electric heating element power varies continuously along at least a portion of the length of the electric heater element(s).

In some implementations, one or more of the electric heating elements may comprise an internal filament in the form of a coil having a helical pitch. The local electric heating element power may vary, e.g. increase or decrease, along at least a portion of the length of the electric heating element, due to changes in the helical pitch of the internal filament.

The fluid flow path may pass through one or more heater tubes. The fluid flow path may pass through a plurality of heater tubes fluidly connected in flow series. In this way, in use, a flow of water may flow through a first heater tube and may then flow through any further heater tubes arranged in series.

The water heater may comprise two or more heater tubes fluidly connected in flow series and forming at least a portion of the fluid flow path. For example, the heater tank may comprise up to 10, up to 20 or up to 50 heater tubes fluidly connected in flow series and forming at least a portion of the fluid flow path. The water heater may comprise two, three, four, five, six, seven, eight, nine or 10 heater tubes fluidly connected in flow series and forming at least a portion of the fluid flow path.

In implementations comprising more than one heater tube, two or more of the heater tubes may be arranged in parallel with each other at least in part.

In implementations comprising more than one heater tube, two or more of the heater tubes may be integrally formed with each other.

One or more of the heater tubes may be straight.

By providing a water heater for an instantaneous water heater as described herein, the packaging for the instantaneous water heater may be designed very differently from known instantaneous water heaters. Such different packaging may allow for much thinner instantaneous water heaters operable to heat a flow of water to the same required temperatures as known instantaneous water heaters. In this way, instantaneous water heaters according to the present disclosure may be located in locations not previously possible, such as in smaller spaces or within cavities in walls or ceilings, for example.

At least one electric heating element may be disposed at least partially within each heater tube. Each electric heating element may be arranged within a heater tube such that fluid, e.g. water, flowing along the flow path contacts an exterior surface of each heating element. In this way, in use, thermal energy may be transferred from each electric heating element to a flow of fluid, e.g. water, flowing along the fluid flow path.

In some embodiments, one or more heater tubes may not comprise an electric heating element disposed within the heater tube.

Each electric heating element may comprise a substantially similar cross section to the cross section of the heater tube in which it is disposed. For example, each electric heating element may comprise a substantially constant circular cross section and may be disposed within heater tubes having a substantially circular cross section. Each electric heating element may be arranged substantially concentrically with an inner wall of a heater tube.

The electric heating element(s) and the heater tube(s) may be configured such that the outer surface of the electric heating elements is close to the inner surface of the heater tube. In this way, a small annular clearance between the electric heating elements and the heater tubes provides good heat transfer from the electric heating elements to the flow of water.

For example, one or more of the electric heating elements may have an outer diameter of up to or at least 3 mm, up to or at least 4 mm, up to or at least 5 mm, up to or at least 6 mm, up to or at least 7 mm, up to or at least 8 mm, up to or at least 9 mm or up to or at least 10 mm. For example, one or more of the electric heating elements may have an outer diameter of approximately 6.25 mm.

For example, one or more of the heater tubes may have an internal diameter of up to or at least 5 mm, up to or at least 6 mm, up to or at least 7 mm, up to or at least 8 mm, up to or at least 9 mm, up to or at least 10 mm, up to or at least 11 mm, up to or at least 12 mm, up to or at least 13 mm, up to or at least 14 mm or up to or at least 15 mm. one or more of the heater tubes may have an internal diameter of approximately 12.35 mm.

An electric heating element may be disposed within each heater tube. For example, if in an embodiment the water heater comprises four heater tubes then the water heater may comprise four electric heating elements, wherein one electric heating element is disposed at least partially within each heater tube.

Each electric heating element may extend along a substantial portion of a given heater tube.

A portion of each heater tube may comprise a seal separating a portion of the heater tube from the fluid flow path. A portion of each electric heating element may extend into the portion sealed from the fluid flow path. The portion of each electric heating element arranged to extend into the portion sealed from the fluid flow path may be configured to form an electrical connection to an electrical power source. In this way, each electric heating element may be configured to form an electrical connection to an electrical power source in a sealed environment. The electrical connection between an electrical power supply and each electrical heating element may be disposed in any suitable location. The sealing means may comprise any suitable means for providing a fluid-tight, e.g. watertight, seal such as, for example, one or more O-rings, or a sealant such as a silicone sealant, for example.

One or more heater tubes may comprise a portion sealed from the fluid flow path at both ends of the heater tube. In this way, each electric heating element may be configured to form an electrical connection with a wire, cable or the like at both ends. Positive connections may be located at either end of each heater tube. Neutral connections may be located at either end of each tube. All the positive connections may be located at one end of the heater tank and all the neutral connections may be located at the opposing end of the heater tank. At least one positive connection and at least one neutral connection may be located at the same end of the heater tank.

Each electric heating element may be configured to have a different electrical heating element power from any adjacent electric heating elements.

Each electric heating element may have a higher electric heating element power than any electric heating elements disposed downstream. In this way, the electrical heating element disposed nearest to the heater tank inlet may have the highest power.

Each heater tube arranged in flow series may comprise a heating element, wherein each heating element has a lower power than any upstream heating element and a higher power than any downstream heating elements.

The first electric heating element may have the highest power of any electric heating elements present. Each electric heating element in flow series along the flow path may have a successively lower power than any electric heating elements disposed upstream. In this way, water flowing through the heater tubes along the flow path may be heated, in use, by heating elements having a successively lower electric heating element power.

In use, for example, fluid, e.g. water, may be conveyed from the or a plumbing supply to the heater tank inlet. The fluid, e.g. water, will then flow through the first heater tube and be heated by the first electric heating element. The fluid will then flow through any further heater tubes and will be heated by corresponding further electric heating elements. In this way, as water flows along the fluid flow path from the heater tank inlet to the heater tank outlet, the water temperature will increase. As the fluid flow path follows the heater tubes in this way, a homogenous heat transfer may be provided from the electric heating elements to the fluid flowing along the fluid flow path.

Known instantaneous heater tanks typically cause a more chaotic flow which can result in uneven heating. Uneven heating can more easily lead to hotspots on the surface of the heating element which in turn can accelerate limescale build up.

Water entering the fluid flow path from the plumbing supply will be heated first, in use, by the first electric heating element. In this way, the water will be heated by the electrical heating element having the highest power when the water temperature is at its lowest.

As water flows along the fluid flow path, the water may be heated by further electric heating elements, located in further heater tubes, having successively lower electric heating element powers. In this way, the water will be heated by the electrical heating element having the lowest power when the water temperature is at its highest.

A flow of water having a lower temperature may more effectively draw heat away from an electrical heating element than a flow of water having a higher temperature. As such, if water having a higher temperature flows over an electric heating element having a higher power, the electric heating element may be more susceptible to hot spots or other localised temperature extremes which may act as nucleation sites for limescale formation.

The electric heating element(s) may have any suitable electric heating element power. A total heating power of the water heater may constitute the sum of the electric heating element power(s) of the electric heating element(s). The total heating power of the water heater may be up to or at least 4 kW, up to or at least 5 kW, up to or at least 6 kW, up to or at least 7 kW, up to or at least 8 kW, up to or at least 9 kW, up to or at least 10 kW, up to or at least 11 kW, up to or at least 12 kW, up to or at least 13 kW, up to or at least 14 kW or up to or at least 15 kW. For example, the total power may be 10.8 kW.

The relative power of the electric heating elements may be configured in any suitable way. The power of the electric heating elements may be configured to provide an evenly distributed power reduction of the electric heating elements along the flow path. For example, each electric heating element may have a power that is X kW lower than the power of an electric heating element disposed immediately upstream, where X is equal to a constant numerical value. For example, each electric heating element may have a power that is X kW higher than the power of an electric heating element disposed immediately downstream, where X is equal to a constant numerical value.

The electric heating elements may be configured such that one half of the electric heating elements provide approximately 50% of the total power and the other half provide approximately 50% of the total power. For example, in an embodiment where the heater tank comprises four electric heating elements, the first and fourth electric heating elements in flow series may be configured to provide a combined 50% of the total power and the second and third electric heating elements in flow series may be configured to provide a combined 50% of the total power.

The electrical heating of each electric heating element may be provided by an internal filament located within each electric heating element. Each internal filament may have a resistance and as such may be arranged to increase in temperature when an electric current passes through. Each internal filament may be arranged in a helix shape extending along a substantial portion of the length of each electric heating element. Each internal filament may comprise a helical coil having a constant or variable pitch. The pitch of the helix may be defined as the height of one complete helix turn, measured parallel to the axis of the helix. The heating power of any electric heating element may be proportional to the helical pitch of the internal filament.

In use, a current may pass through each internal filament and increase in temperature. In this way, thermal energy may be transferred to the external surface of each electric heating element which may then be operable to heat a flow of water flowing within the heater tubes.

The electrical power of each electric heating element may be determined by the conductive properties and/or configuration of the internal filament.

The heating power of any portion of any electric heating element may be proportional to the helical pitch of the internal filament.

The instantaneous water heater may comprise one or more electric heating elements wherein at least one electric heating element has a variable electric power density along its length. One or more of the electric heating elements may be configured to have a power that progressively reduces along at least a portion of its length.

For internal filaments having the same conductive properties, an increase in helical pitch may provide a reduction in heating power provided and a decrease in helical pitch may pro vide a reduction in heating power provided.

One or more electric heating elements may comprise a different internal filament helical pitch to one or more adjacent electric heating elements. Each electric heating element may comprise an internal filament having a greater helical pitch than any upstream electric heating elements. In this way, electric heating elements having different electric power to adjacent electric heating elements may be provided.

One or more electric heating elements may comprise two or more electric heating element segments. One or more of the electric heating element segments may comprise a different electrical power from one or more adjacent electric heating element segments. Each electric heating element segment may comprise a higher electric heating element segment power than any segments disposed downstream. Each electric heating element segment may have a lower power than the electric heating element segment disposed immediately upstream. The heating power of any electric heating element segment of any electric heating element may be proportional to the helical pitch of the internal filament.

One or more of the electric heating elements may comprise any suitable number of electric heating element segments, for example, at least 2 segments, or at least 3, 4, 5, 6, 7, 8, 9 or at least 10 electric heating element segments. One or more of the electric heating elements may comprise up to or at least 10 electric heating element segments, up to or at least 20 electric heating element segments or up to or at least 50 electric heating element segments.

One or more of the electric heating element segments may have a length of at least 5 mm, up to or at least 10 mm, up to or at least 50 mm, up to or at least 100 mm or up to or at least 200 mm.

One or more of the electric heating elements may have an active heated length of up to or at least 100 mm, up to or at least 200 mm, up to or at least 500 mm or up to or at least 1000 mm.

The fluid flow path may have a length of at least 100 mm, up to or at least 500 mm, up to or at least 1000 mm, up to or at least 2000 mm, up to or at least 3000 mm or up to or at least 5000 mm.

The heater tank may comprise a plurality of electric heating elements where each electric heating element is divided into a plurality of electric heating element segments. The electric heating element segment located furthest upstream along the flow path may have the highest power. The electric heating element segment located furthest downstream along the flow path may have the lowest power.

One or more of the electric heating element segments may comprise a different internal filament helical pitch than one or more adjacent electric heating element segments. The heating power of any electric heating element segment of any electric heating element may be proportional to the helical pitch of the internal filament.

The internal filament may be arranged such that the helical pitch is constant along the length of each electric heating element segment. Each electric heating element segment may comprise a helical pitch that is greater than the helical pitch of the filament of any adjacent upstream electric heating element segment. In this way, the internal filament extending along each electric heating element segment may have a helical pitch greater than the section of internal filament extending along the electric heating element segment immediately upstream.

In some embodiments, the helical pitch of the internal filament may be continuously variable along the length of one or more electric heating elements and as such may be configured to provide a continuously variable electrical heating power along the length of one or more electric heating elements. The helical pitch may continuously increase along the length of one or more electric heating elements in a downstream direction.

The electric heating elements may be configured such that the electric heating element power of any electric heating element is higher than the electric heating element power of any electric heating element disposed downstream.

A flow of water having a lower temperature may more effectively draw heat away from a portion of an electrical heating element than a flow of water having a higher temperature. As such, if water having a higher temperature flows over a segment of an electric heating element having a higher power, the segment of the electric heating element is more susceptible to hot spots or other localised temperature extremes which may act as nucleation sites for limescale formation.

The power density of the electric heating element(s) is distributed unevenly along the flow path and as such creates a relationship whereby power density is inversely related to the water temperature along the flow path. Therefore, the disclosed water heater may be configured to heat a flow of water where downstream water having a higher temperature flows over heating elements having a lower power and thus reduces the susceptibility to hot spots and limescale formation.

Upon the heater tank or an instantaneous water heater comprising the heater tank being switched off, non-flowing water near to the heater tank outlet is heated by residual heat from a heating element having the lowest local electric heating element power within the heater tank. In this way, the residual heat transferred from the electric heating element located furthest downstream is minimised and therefore reduces the peak temperature of the water. Therefore, the water heater reduces the risk of temperature extremes and the dangers of “hot shot”.

A second aspect provides an instantaneous water heater comprising a heater tank of the first aspect.

The instantaneous water heater may include control circuitry configured to control operation of the heater tank.

The heater tank may be surrounded at least partially by a casing. The casing may also surround at least partially further components of the instantaneous water heater, e.g. control circuitry configured to control operation of the heater tank.

A user may be able to control the flow rate and temperature of fluid, e.g. water, delivered, in use, by the instantaneous water heater to a fluid delivery device downstream of the instantaneous water heater. User control of the instantaneous water heater may be facilitated by any suitable user input means operably connected to the control circuitry configured to control operation of the heater tank.

A third aspect provides an electric shower comprising a heater tank of the first aspect or an instantaneous water heater of the second aspect.

The electric shower may comprise any suitable size or shape. The electric shower may be suitable to be mounted on a surface such as a wall located within, for example, a bathroom. The electric shower may be suitable for being mounted within a wall or a ceiling cavity.

A fourth aspect provides a plumbing system comprising a heater tank of the first aspect, an instantaneous water heater of the second aspect and/or an electric shower of the second aspect.

The plumbing system may be an ablutionary system. The ablutionary system may be a bath system or a shower system.

The heater tank inlet may be in fluid communication with a fluid supply, e.g. a water supply.

The instantaneous water heater may be operable to deliver fluid, e.g. water, to one or more fluid delivery device(s) at a user-selected temperature and/or flow rate.

One or more of the fluid delivery devices may comprise a tap, a faucet, a sprayer or a shower head.

The plumbing system may be an ablutionary system, e.g. an electric shower system.

The electric shower system may comprise an electric shower unit. The electric shower unit may be configured to be mounted on a wall. The electric shower unit may comprise a casing housing the instantaneous water heater. The instantaneous water heater may be connected to a water supply point such as a plumbing supply. A hose may provide fluid communication from the instantaneous water heater to a spray head located downstream thereof. A shower tray or bath tub may be present to collect the water emitted from the spray head.

A fifth aspect provides a dishwasher or a washing machine comprising a heater tank according to the first aspect.

A sixth aspect provides a bath system or a recirculating shower system, in which a heater tank according to the first aspect is operable to heat a recirculated stream of water.

A seventh aspect provides an electric shower system comprising a waste water heat recovery system and a heater tank according to the first aspect or an instantaneous water heater according to the second aspect.

The waste water heat recovery system may be configured to transfer heat from a waste water stream to a stream of cold water, e.g. from a mains supply, being conveyed to the instantaneous water heater.

An eighth aspect provides a whole building water heater comprising a heater tank according to the first aspect or an instantaneous water heater according to the second aspect.

A ninth aspect provides a bath fill comprising a heater tank according to the first aspect or an instantaneous water heater according to the second aspect.

The person skilled in the art will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

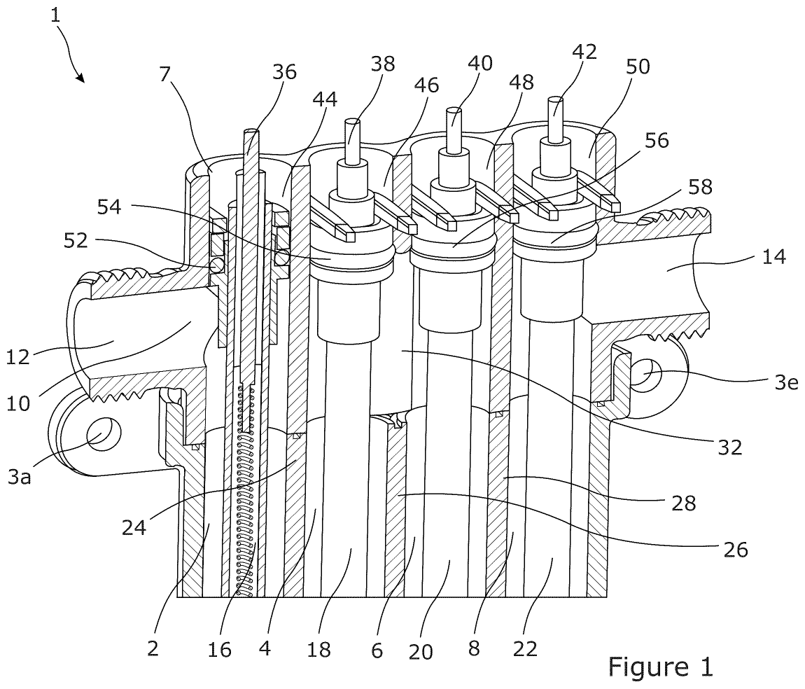

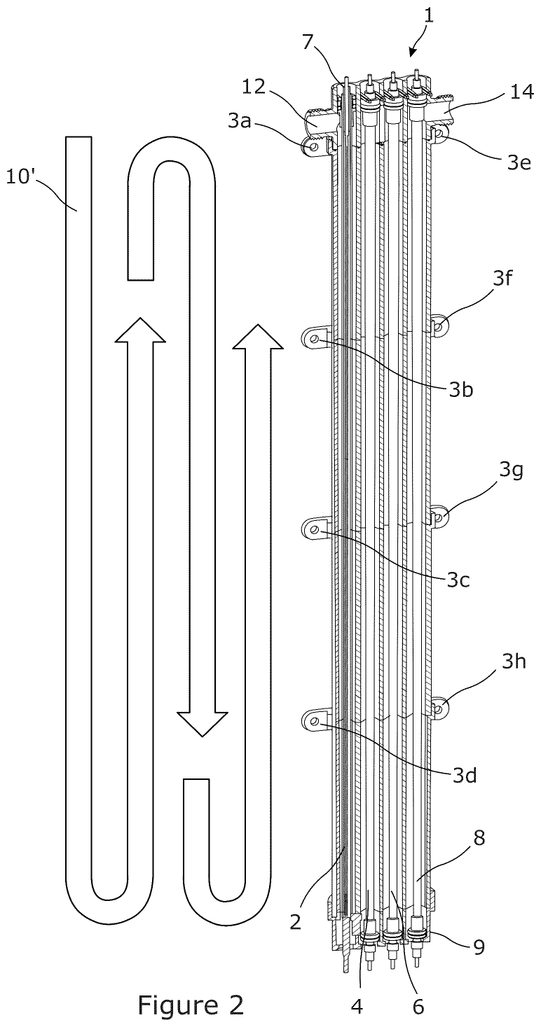

FIG. 2 shows a sectional view of a heater tank 1 for an instantaneous water heater. FIG. 1 shows a sectional view of a portion of the heater tank 1.

Referring to FIGS. 1 and 2, the heater tank 1 has a heater tank inlet 12 and a heater tank outlet 14 and a fluid flow path 10 from the heater tank inlet 12 to the heater tank outlet 14.

The fluid flow path 10 passes through, in series, a first heater tube 2, a second heater tube 4, a third heater tube 6 and a fourth heater tube 8. The first heater tube 2, the second heater tube 4, the third heater tube 6 and the fourth heater tube 8 are integrally formed with each other, although they need not be. Each one of the first heater tube 2, the second heater tube 4, the third heater tube 6 and the fourth heater tube 8 extends from a first end 7 of the heater tank 1 to a second end 9 of the heater tank 1. The first heater tube 2, the second heater tube 4, the third heater tube 6 and the fourth heater tube 8 are arranged in parallel with each other.

At a point near the first end 7 of the heater tank 1, the first heater tube 2 is in fluid communication with the heater tank inlet 12. At a point near the second end 9 of the heater tank 1, the second heater tube 4 is in fluid communication with the first heater tube 2. At a point near the first end 7 of the heater tank 1, the third heater tube 6 is in fluid communication with the second heater tube 4. At a point near the second end 9 of the heater tank 1, the fourth heater tube 8 is in fluid communication with the third heater tube 6. At a point near the first end 7 of the heater tank 1, the heater tank outlet 14 is in fluid communication with the fourth heater tube 8.

As indicated schematically by a block arrow 10′ (FIG. 2), the fluid flow path 10 from the heater tank inlet 12 to the heater tank outlet 14 passes through, in series, the first heater tube 2, the second heater tube 4, the third heater tube 6 and the fourth heater tube 8. In use, fluid flows in a first direction from the first end 7 of the heater tank 1 towards the second end 9 of the heater tank 1 along the first heater tube 2 and the third heater tube 6. In use, fluid flows in a second direction opposite to the first direction (i.e. from the second end 9 of the heater tank 1 towards the first end 7 of the heater tank 1) along the second heater tube 4 and the fourth heater tube 8.

A first electric heating element 16 extends longitudinally within the first heater tube 2. The first electric heating element 16 extends from the first end 7 of the heater tank 1 to the second end 9 of the heater tank 1. The first electric heating element 16 has an electric heating element power and is operable to heat fluid, e.g. water, flowing, in use, within the first heater tube 2.

A second electric heating element 18 extends longitudinally within the second heater tube 4. The second electric heating element 18 extends from the first end 7 of the heater tank 1 to the second end 9 of the heater tank 1. The second electric heating element 18 has an electric heating element power and is operable to heat fluid, e.g. water, flowing, in use, within the second heater tube 4.

A third electric heating element 20 extends longitudinally within the third heater tube 6. The third electric heating element 20 extends from the first end 7 of the heater tank 1 to the second end 9 of the heater tank 1. The third electric heating element 20 has an electric heating element power and is operable to heat fluid, e.g. water, flowing, in use, within the third heater tube 6.

A fourth electric heating element 22 extends longitudinally within the fourth heater tube 8. The fourth electric heating element 22 extends from the first end 7 of the heater tank 1 to the second end 9 of the heater tank 1. The fourth electric heating element 22 has an electric heating element power and is operate to heat fluid, e.g. water, flowing, in use, within the fourth heater tube 8.

The heater tank 1 is adapted to be fixed to a mounting surface or a structure. The heater tank 1 comprises eight regularly-spaced mounting tabs 3a, 3b, 3c, 3d, 3e, 3f, 3g, 3h. Each mounting tab 3a, 3b, 3c, 3d, 3e, 3f, 3g, 3h comprises an aperture for receiving a mechanical fixing means such as a screw.

When installed as part of an instantaneous water heater, the heater tank 1 may be surrounded at least partially by a casing (not shown) along with further components of the instantaneous water heater, e.g. control circuitry configured to control operation of the heater tank 1. A user may be able to control the flow rate and temperature of water delivered by the instantaneous water heater to a fluid delivery device downstream of the instantaneous water heater. User control of the instantaneous water heater may be facilitated by any suitable user input means operably connected to the control circuitry configured to control operation of the heater tank 1.

Each of the first, second, third and fourth electric heating elements 16, 18, 20, 22 comprises a substantially circular cross-section. Each of the first, second, third and fourth electric heating elements 16, 18, 20, 22 is arranged substantially centrally within its respective heater tube 2, 4, 6, 8 and has a smaller outer diameter than the inner diameter of its respective heater tube 2, 4, 6, 8. In this way, the fluid flow path 10 has an annular cross section along a substantial portion of each heater tube 2, 4, 6, 8. A width of the annular cross section of the fluid flow path 10 may be defined as the distance from an external surface of the electric heating element to an internal surface of the corresponding heater tube, in a direction perpendicular to a longitudinal axis of the fluid flow path 10 along said heater tube. In some embodiments, the fluid flow path 10 along at least a portion of one or more of the heater tubes 2, 4, 6, 8 may comprise an annular cross section having a varying width. The width of the annular cross section of the fluid flow path 10 may be up to or at least 1 mm, up to or at least 3 mm, up to or at least 5 mm or up to 1 cm. By having a relatively small width of the annular cross section, the flowing fluid, e.g. water, may be constrained such that it all remains in close proximity to a given electrical heating element as it flows along a given heater tube. Hence, heat transfer from the electrical heating element to the fluid, e.g. water, may be more efficient.

In this example, each of the first, second, third and fourth electric heating elements 16, 18, 20, 22 has an active heated length of 500 mm.

In the illustrated implementation, as can be seen in FIG. 1 there is a first shared wall 24 between the first heater tube 2 and the second heater tube 4, a second shared wall 26 between the second heater tube 4 and the third heater tube 6 and a third shared wall 28 between the third heater tube 6 and the fourth heater tube 8. Fluid communication from the first heater tube 2 to the second heater tube 4 is provided by an aperture through the first shared wall 24, the aperture being located at a point near the second end 9 of the heater tank 1. Fluid communication from the second heater tube 4 to the third heater tube 6 is provided by an aperture 32 through the second shared wall 26, the aperture 32 being located at a point near the first end 7 of the heater tank 1. Fluid communication from the third heater tube 6 to the fourth heater tube 8 is provided by an aperture through the third shared wall 28, the aperture being located at a point near the second end 9 of the heater tank 1.

Each of the first, second, third and fourth electric heating elements 16, 18, 20, 22 comprises an electrical connector 36, 38, 40, 42 located near to the first end 7 of the heater tank 1. The electrical connectors 36, 38, 40, 42 are configured to be connected electrically to an electrical power supply such as, for example, a mains power supply. The electrical connectors 36, 38, 40, 42 may each form an electrical connection, in use, with an electrical power supply by any suitable means.

The electrical connectors 36, 38, 40, 42 are each located within a sealed portion 44, 46. 48, 50. Each sealed portion 44, 46. 48, 50 provides a watertight volume such that the electrical connectors 36, 38, 40, 42 are sealed away from fluid, e.g. water, ingress. A watertight seal for each sealed portions 44, 46. 48, 50 is provided by an O-ring seal 52, 54, 56, 58. The O-ring seals 52, 54, 56, 58 may comprise any suitable material such as a rubber or any suitable polymeric material. Other suitable sealing means may be employed instead of, or in addition to, one or more of the O-ring seals. There may be an electrical connector arranged in a similar sealed portion at the other end of each of the first, second, third and fourth electric heating elements 16, 18, 20, 22.

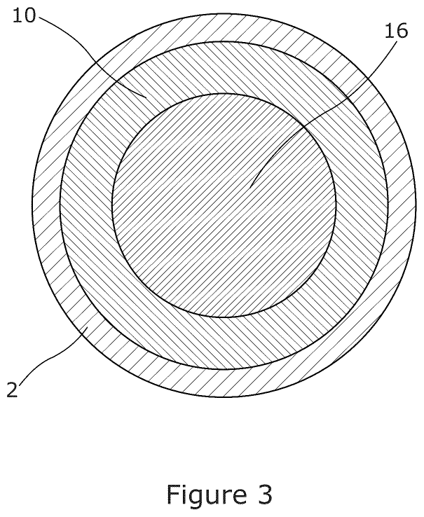

FIG. 3 shows a cross-sectional view through the first heater tube 2. The first electric heating element 16 comprises a substantially constant circular cross section and is disposed within the first heater tube 2, the first heater tube 2 having a substantially circular cross section. The first electric heating element 16 is arranged substantially concentrically within the first heater tube 2.

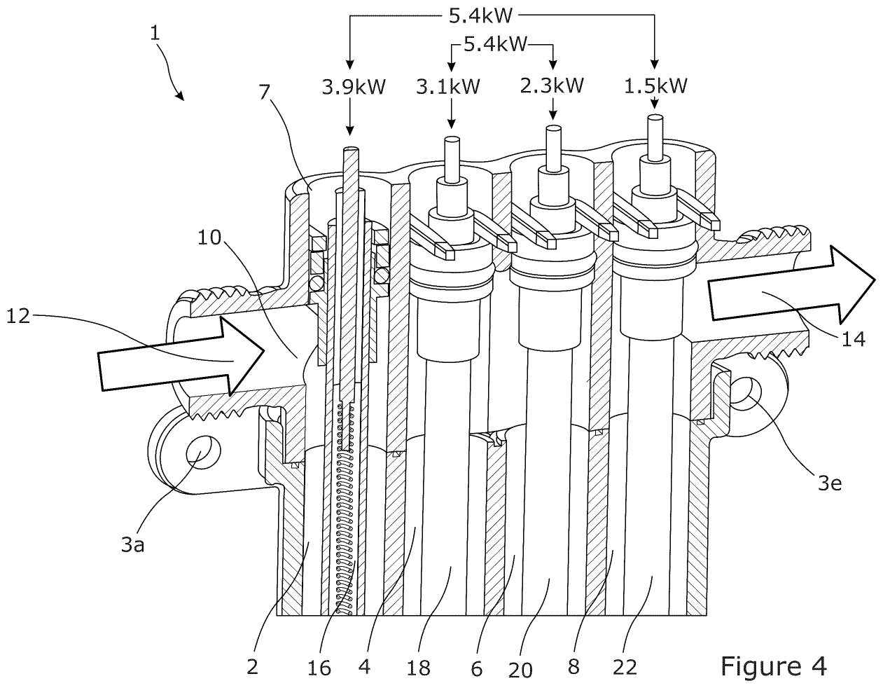

As illustrated in FIG. 4, the first electric heating element 16 has an electric heating element power of 3.9 kW, the second electric heating element 18 has an electric heating element power of 3.1 kW, the third electric heating element 20 has an electric heating element power of 2.3 kW, and the fourth electric heating element 22 has an electric heating element power of 1.5 kW. In this way, the electric heating element power of successive electric heating elements reduces downstream. As such, as water flows along the flow path 10 the water is heated by electric heating elements having successively lower electric heating element powers. It should be understood that the electric heating elements may have any suitable electric heating element powers.

As illustrated in FIG. 4, The electric heating elements 16, 18, 20, 22 may be connected such that the first electric heating element 16 and the fourth electric heating element 22 form a first pair, and the second electric heating element 18 and third electric heating element 20 form a second pair. In this way, the first pair and the second pair each have a total power of 5.4 kW. Therefore, the total power of all four electric heating elements 16, 18, 20, 22 is 10.8 kW. A person skilled in the art will understand that the power values provided in the examples are only example values and that the power may be increased or decreased. By matching or nearly matching the total power of the first pair of electric heating elements and the second pair of electric heating elements, the electrical connections and electrical circuitry may be simplified.

For example, the electrical heating of one or more of the first, second, third and fourth electric heating elements 16, 18, 20, 22 may be provided by an internal filament located within the electric heating element 16, 18, 20, 22. Each internal filament has a resistance and as such increases in temperature when an electric current passes through. Each internal filament may be arranged in a coil extending along a substantial portion of the length of each electric heating element 16, 18, 20, 22. In use, as a current passes through each internal filament and increases in temperature, thermal energy is transferred to the outer surface of each electric heating element 16, 18, 20, 22.

The electrical power of each electric heating element 16, 18, 20, 22 may be determined by the conductive properties and configuration of the internal filament located within each electric heating element 16, 18, 20, 22. For internal filaments having the same conductive properties, an increase in helical pitch will provide a reduction in heating power provided. In some implementations, each electric heating element 16, 18, 20, 22 may comprise an internal filament having a greater helical pitch than any upstream electric heating elements.

In implementations, the electric heating elements may be connected electrically in two or more parallel circuits. For example, all of the positive connections may be connected to the electric heating elements 16, 18, 20, 22 at the first end 7 of the heater tank 1 and all of the neutral connections may be connected to the electric heating elements 16, 18, 20, 22 at the second end 9 of the heater tank 1. The control circuitry may comprise a printed circuit board, which may, for example, be located relatively close to the first end 7 of the heater tank 1. In such a configuration, a relatively large, thick cable may be required to connect the neutral connections to the printed circuit board.

Alternatively, the electric heating elements may be connected electrically in series. By connecting the electric heating elements in series, less additional electrical componentry may be required. For example, there may be no need to employ a relatively large, thick cable to connect the neutral connections at the second end of the heater tank 1 to the printed circuit board located relatively close to the first end 7 of the heater tank 1. Also, waste heat generation may be reduced.

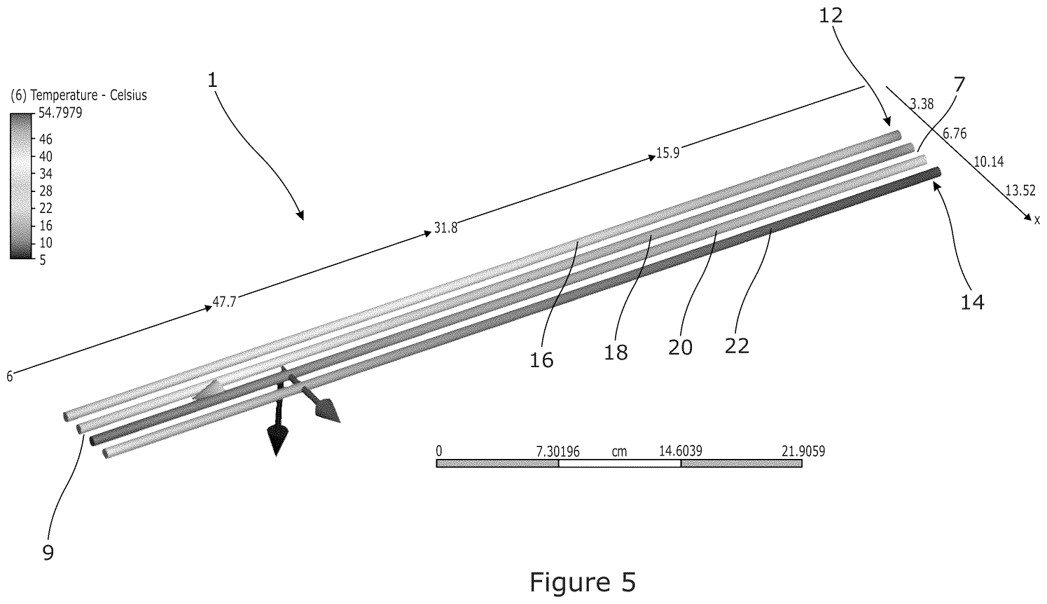

FIG. 5 shows some results of a computational fluid dynamics simulation in the form of a heat map representing the first, second, third and fourth electric heating elements 16, 18, 20, 22 disposed within the heater tank 1. In the scenario being simulated the heater tank 1 receives at the heater tank inlet 12 a flow of water from a standard UK cold water mains supply (approximately 10° C.). The heater tank 1 operates to heat the water flowing therethrough to a temperature of approximately 40° C. as it exits the heater tank outlet 14, 40° C. being a typical user-preferred shower temperature. The flow rate through the heater tank 1 is a typical flow rate for an electric shower.

The surface temperature of the electric heating elements 16, 18, 20, 22 is indicated by the shading. The surface temperature of the electric heating elements 16, 18, 20, 22 varies along the flow path 10. The surface temperature of each electric heating element 16, 18, 20, 22 increases with distance along the flow path 10 from the heater tank inlet 12 to the heater tank outlet 14. Generally, the surface temperature of the heating elements 16, 18, 20, 22 increases from a minimum surface temperature adjacent the heater tank inlet 12 to a maximum surface temperature adjacent the heater tank outlet 14. Referring to FIG. 5, the minimum surface temperature is approximately 5° C. and the maximum surface temperature is around 54.8° C. The average surface temperature of the electric heating elements 16, 18, 20, 22 is approximately 34° C.

In use, the water temperature rises progressively as it flows along the flow path 10, thereby avoiding hot spots that may lead to limescale build up. Further, the inventors have discovered that heating element surface temperatures above 55° C. can lead to significantly more limescale build up compared to heating element surface temperatures below 55° C. In this example, the maximum surface temperature is just below 55° C. Consequently, FIG. 5 shows that the heater tank 1 can provide the heating power required to heat a flow of water to a suitable temperature for a shower, whilst minimising, or even avoiding, the occurrence of heating element surface temperatures associated with causing significant limescale build up.

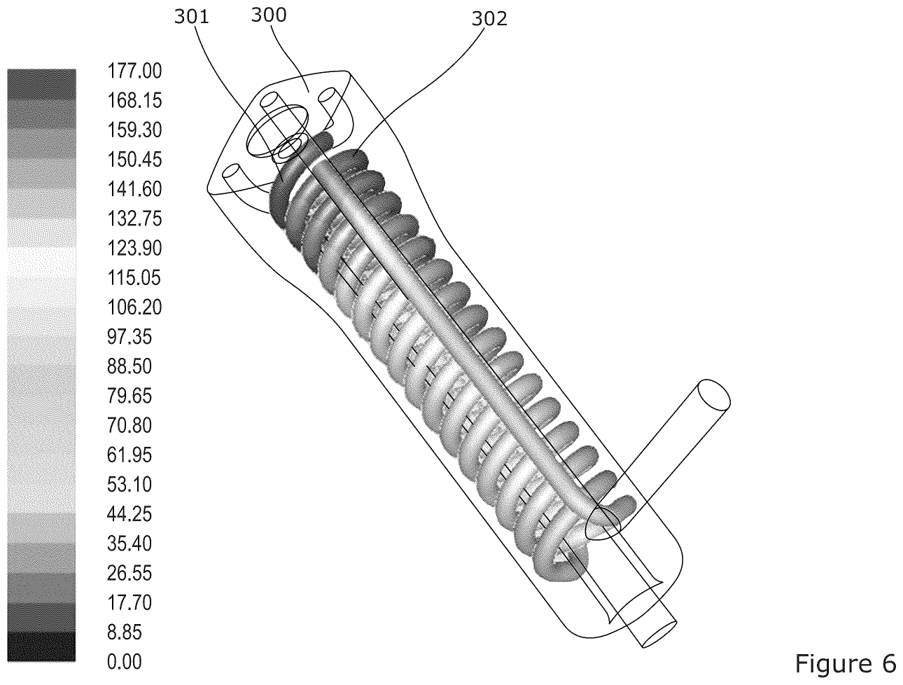

FIG. 6 shows some results of a comparative computational fluid dynamics simulation in the form of a heat map representing a first helical electric heating element 301 and a second helical electric heating element 302 operable to heat water flowing through a heater tank 300. The first helical electric heating element 301 and the second helical electric heating element 302 are intertwined with each other. This arrangement is modelled on the arrangement of the heater tank of the Mira Sport Max 10.8 kW electric shower, manufactured and sold by Kohler Mira Limited. The first helical electric heating element and the second helical electric heating element together provide a total electrical power of 10.8 kW.

In the scenario being simulated the heater tank 300 receives at a heater tank inlet a flow of water from a standard UK cold water mains supply (approximately 10° C.). The first helical electric heating element 301 and the second helical electric heating element 302 operate to heat the water through the heater tank 300 to a temperature of approximately 40° C. as it exits the heater tank outlet, 40° C. being a typical user-preferred shower temperature. The flow rate through the heater tank 300 is a typical flow rate for an electric shower and is comparable to the flow rate modelled in the computational fluid dynamics simulation the results of which are illustrated in FIG. 5.

The surface temperature of the first helical electric heating element 301 and the second helical electric heating element 302 is indicated by the shading. The surface temperature of the first and second helical electric heating elements 301, 302 varies along a flow path from the heater tank inlet through the heater tank 300 to the heater tank outlet. Referring to FIG. 6, a minimum surface temperature is approximately 60° C. and a maximum surface temperature is around 177° C. The average surface temperature of the first helical electrical heating element 301 and the second helical electric heating element 302 is approximately 120° C.

Therefore, it will be appreciated that the maximum heater temperature is much higher for the arrangement shown in FIG. 6 than that shown in FIG. 5. Further, all (or almost all) of the first helical electric heating element 301 and the second helical electric heating element 302 has a surface temperature in excess of 55° C. Generally, higher heating element surface temperatures may result, in use, in more significant limescale build-up than lower heating element surface temperatures. Further, this effect can be more pronounced for heating element surface temperatures above 55° C. Accordingly, the results of a comparison of the simulation results shown in FIGS. 5 and 6 suggest that the heater tank 1 may be less prone to limescale build-up, in use.

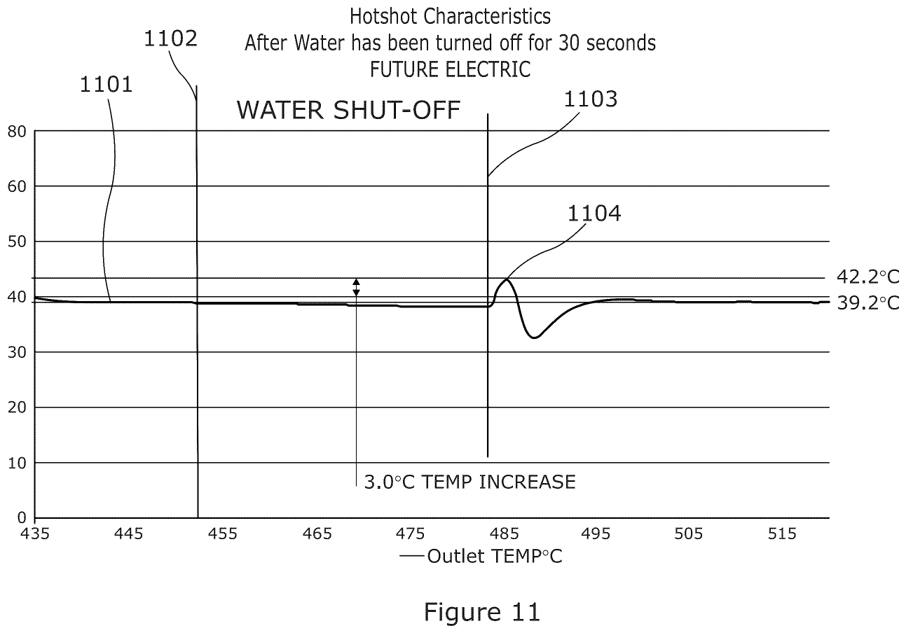

FIG. 11 is a graph illustrating the results of a hot shot test carried out on the heater tank 1. Temperature in ° C. is marked on the y-axis. Time in seconds is marked on the x-axis.

The heater tank 1 is operated to provide a flow of water exiting the heater tank outlet 14 having a desired temperature of 40° C. A first line 1101 shows the variation in the temperature of water exiting the heater tank outlet over the course of the hot shot test.

During an initial part of the hot shot test, the water exiting the heater tank outlet 14 has a substantially constant temperature of approximately 40° C. The flow of water through the heater tank 1 is then shut off for a period of 30 seconds. A first vertical line 1102 indicates the time at which the flow of water is stopped and a second vertical line 1103 indicates the time at which the flow of water is restarted. Immediately after the flow of water is restarted, there is a hot shot event 1104, in which the temperature of the water exiting the heater tank outlet 14 increases quickly from 39.2° C. to a peak of 42.2° C. After the hot shot event 1104, the temperature of the water exiting the heater tank outlet 14 drops to a minimum of around 32° C. before reverting to having a substantially constant temperature of approximately 40° C.

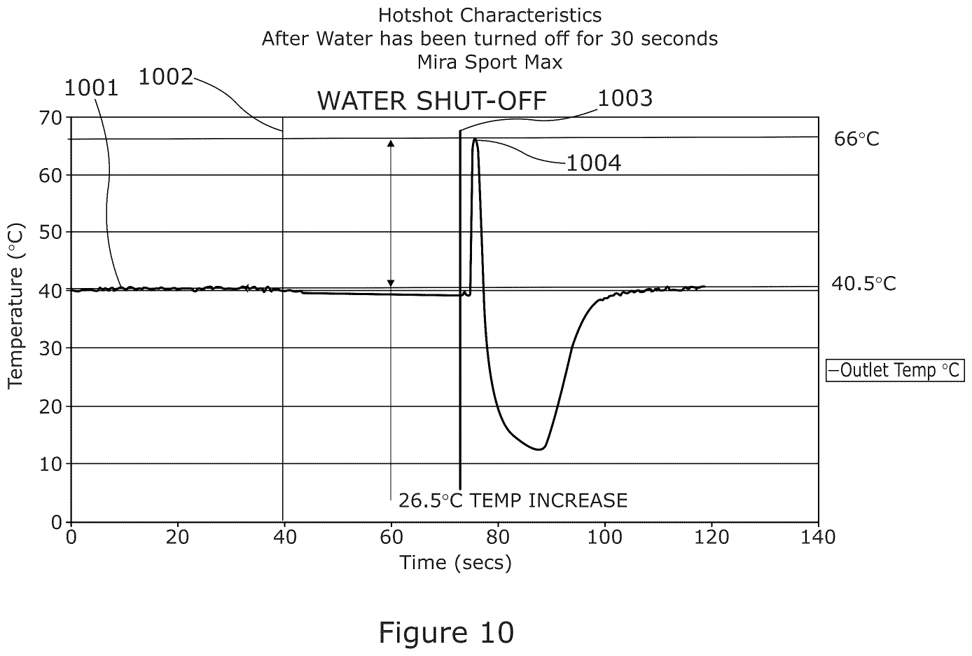

FIG. 10 is a graph illustrating the results of a comparative hot shot test carried out on a heater tank from a heater tank of the Mira Sport Max 10.8 kW electric shower, manufactured and sold by Kohler Mira Limited. Temperature in ° C. is marked on the y-axis. Time in seconds is marked on the x-axis.

The heater tank is operated to provide a flow of water exiting a heater tank outlet having a desired temperature of 40° C. A first line 1001 shows the variation in the temperature of water exiting the heater tank outlet over the course of the hot shot test.

During an initial part of the hot shot test, the water exiting the heater tank outlet has a substantially constant temperature of approximately 40° C. The flow of water through the heater tank is then shut off for a period of just over 30 seconds. A first vertical line 1002 indicates the time at which the flow of water is stopped and a second vertical line 1003 indicates the time at which the flow of water is restarted. Immediately after the flow of water is restarted, there is a hot shot event 1004, in which the temperature of the water exiting the heater tank outlet 14 increases quickly from 40.5° C. to a peak of 66° C., i.e. there is a temperature increase of 26.5° C. After the hot shot event 1004, the temperature of the water exiting the heater tank outlet drops to a minimum of around 13° C. before reverting reverts to having a substantially constant temperature of approximately 40° C.

The hot shot event 1004 in FIG. 10 is considerably more significant than the hot shot event 1104 in FIG. 11. In the hot shot event 1004 in FIG. 10, the peak water temperature would be very uncomfortable for a user of the shower. In contrast, the hot shot event 1104 in FIG. 11 would be much less noticeable and/or uncomfortable for the user of the shower. Accordingly, the results of a comparison of the hot shot test results shown in FIGS. 10 and 11 suggest that the heater tank 1 may be less prone to significant hot shot events, which may benefit user comfort, convenience and/or safety.

A much larger fluctuation in the temperature of the water exiting the heater tank outlet during the period between the restart of the flow of water and the water exiting the heater tank outlet reverting to having a substantially constant temperature of approximately 40° C. is shown in FIG. 10 than in FIG. 11. This much smaller fluctuation in the temperature of the water exiting the heater tank outlet 14 of the heater tank 1 would be less noticeable and/or uncomfortable for a user of the shower.

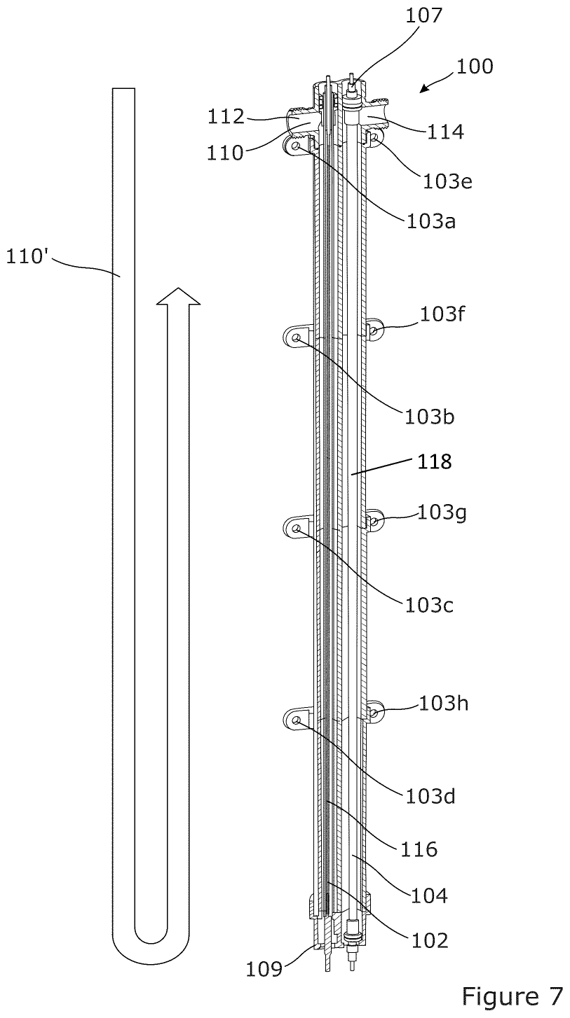

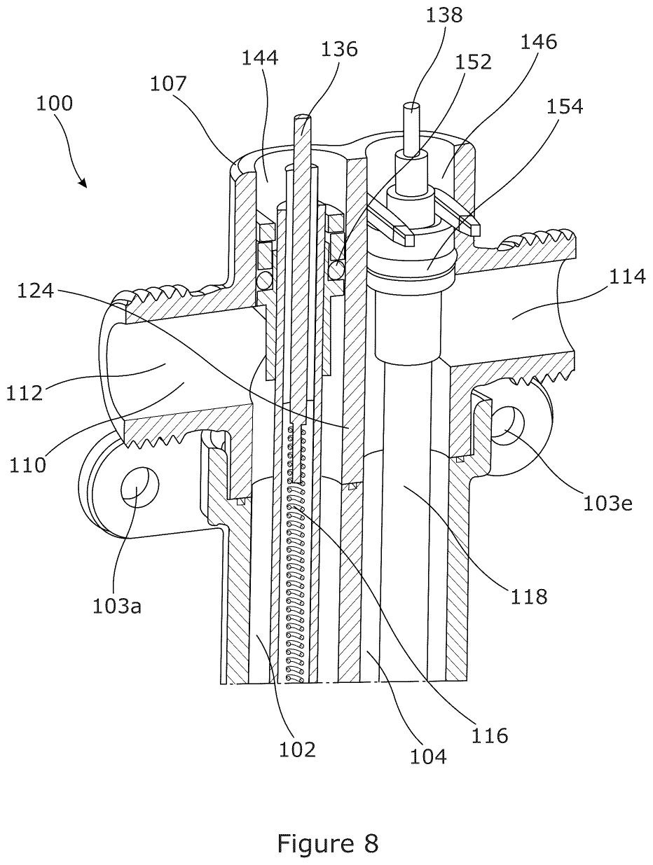

Referring to FIGS. 7 and 8, another example embodiment of a heater tank 100 for an instantaneous water heater is shown.

The heater tank 100 has a heater tank inlet 112 and a heater tank outlet 114 and a fluid flow path 110 from the heater tank inlet 112 to the heater tank outlet 114.

The fluid flow path 110 passes through, in series, a first heater tube 102 and a second heater tube 104. The first heater tube 102 and the second heater tube 104 are integrally formed with each other, although they need not be. Each one of the first heater tube 102 and the second heater tube 104 extends from a first end 107 of the heater tank 100 to a second end 109 of the heater tank 100. The first heater tube 102 and the second heater tube 104 are arranged in parallel with each other.

At a point near the first end 107 of the heater tank 100, the first heater tube 102 is in fluid communication with the heater tank inlet 112. At a point near the second end 109 of the heater tank 100, the second heater tube 104 is in fluid communication with the first heater tube 102. At a point near the first end 107 of the heater tank 100, the heater tank outlet 114 is in fluid communication with the second heater tube 104.

As indicated schematically by a block arrow 110′ (FIG. 7), the fluid flow path 110 from the heater tank inlet 112 to the heater tank outlet 114 passes through, in series, the first heater tube 102 and the second heater tube 104. In use, fluid, e.g. water, flows in a first direction from the first end 107 of the heater tank 100 towards the second end 109 of the heater tank 100 along the first heater tube 102. In use, fluid, e.g. water, flows in a second direction opposite to the first direction (i.e. from the second end 109 of the heater tank 100 towards the first end 107 of the heater tank 100) along the second heater tube 104.

A first electric heating element 116 extends longitudinally within the first heater tube 102. The first electric heating element 116 extends from the first end 107 of the heater tank 100 to the second end 109 of the heater tank 100. The first electric heating element 116 has an electric heating element power and is operable to heat fluid, e.g. water, flowing, in use, within the first heater tube 102.

A second electric heating element 118 extends longitudinally within the second heater tube 104. The second electric heating element 118 extends from the first end 107 of the heater tank 100 to the second end 109 of the heater tank 100.

The heater tank 100 is adapted to be fixed to a mounting surface of a structure. The heater tank 100 comprises eight regularly-spaced mounting tabs 103a, 103b, 103c, 103d, 103e, 103f, 103g, 103h. Each mounting tab 103a, 103b, 103c, 103d, 103e, 103f, 103g, 103h comprises an aperture for receiving a mechanical fixing means such as a screw.

When installed as part of an instantaneous water heater, the heater tank 100 may be surrounded at least partially by a casing (not shown) along with further components of the instantaneous water heater, e.g. control circuitry configurated to control operation of the heater tank 100. A user may be able to control the flow rate and temperature of fluid, e.g. water, delivered by the instantaneous water heater to a fluid delivery device downstream of the instantaneous water heater. User control of the instantaneous water heater may be facilitated by any suitable user input means operably connected to the control circuitry configured to control operation of the heater tank 100.

Each of the first and second electric heating elements 116, 118 comprises a substantially circular cross-section. Each of the first and second electric heating elements 116, 118 is arranged substantially centrally within its respective heater tube 102, 104 and has a smaller outer diameter than the inner diameter of its respective heater tube 102, 104. In this way, the fluid flow path 110 has an annular cross section along a substantial portion of each heater tube 102, 104. A width of the annular cross section of the fluid flow path 110 may be defined as the distance from an external surface of the electric heating element to an internal surface of the corresponding heater tube, in a direction perpendicular to a longitudinal axis of the fluid flow path 110 along said heater tube. In some embodiments, the fluid flow path 110 along at least a portion of one or more of the heater tubes 102, 104 may comprise an annular cross section having a varying width. The width of the annular cross section of the fluid flow path 10 may be up to or at least 1 mm, up to or at least 3 mm, up to or at least 5 mm or up to 1 cm. By having a relatively small width of the annular cross section, the flowing fluid, e.g. water, may be constrained such that it all remains in close proximity to a given electrical heating element as it flows along a given heater tube. Hence, heat transfer from the electrical heating element to the fluid, e.g. water, may be more efficient.

In the illustrated implementation, as can be seen in FIG. 8 there is a shared wall 124 between the first heater tube 102 and the second heater tube 104. Fluid communication from the first heater tube 102 to the second heater tube 1044 is provided by an aperture through the shared wall 124, the aperture being located at a point near the second end 109 of the heater tank 100.

Each of the first and second electric heating elements 116, 118 comprises an electrical connector 136, 138 located near to the first end 107 of the heater tank 100. The electrical connectors 136, 138 are configured to be connected electrically to an electrical power supply such as, for example, a mains power supply. The electrical connectors 136, 138 may each form an electrical connection, in use, with an electrical power supply by any suitable means.

The electrical connectors 136, 138 are each located within a sealed portion 144, 146. Each sealed portion 144, 146 provides a watertight volume such that the electrical connectors 136, 13, are sealed away from fluid, e.g. water, ingress. A watertight seal for each sealed portion 144, 146 is provided by an O-ring seal 152, 154. The O-ring seals 152, 154 may comprise any suitable material such as a rubber or any suitable polymeric material. Other suitable sealing means may be employed instead of, or in addition to, one or more of the O-ring seals. There may be an electrical connector arranged in a similar sealed portion at the other end of each of the first and second electric heating elements 116, 118.

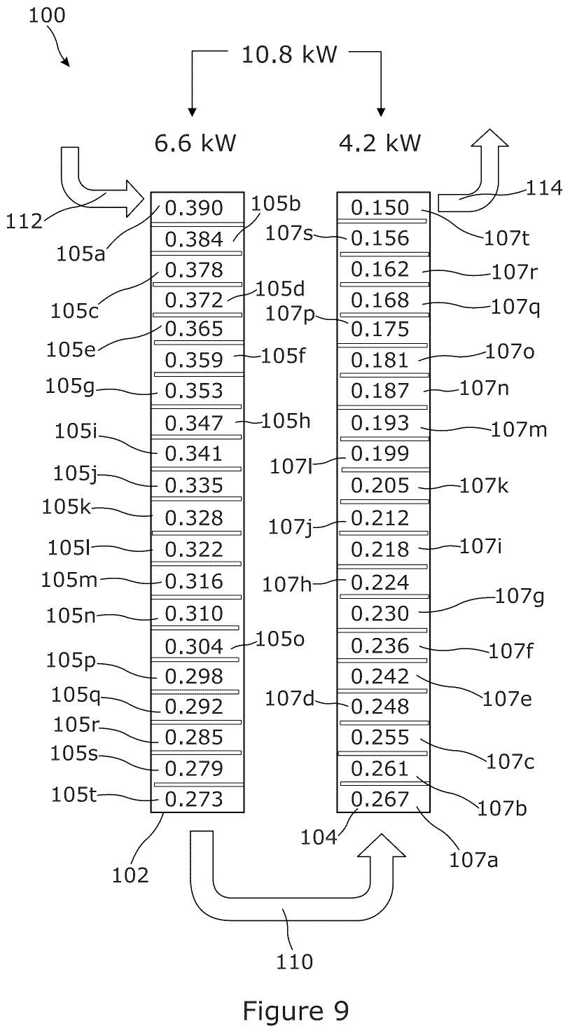

As illustrated in FIG. 9, the first electric heating element 102 has an electric heating power of 6.6 kW and the second electric heating element 104 has an electric heating power of 4.2 kW. In this way, the electric heating element power of successive heating elements reduces downstream. As such, as fluid, e.g. water, flows along the fluid flow path 110 the fluid, e.g. water, is heating be electric heating elements having successively lower electric heating element powers. The total power of the first heating element 102 and the second heating element 104 is kW. A person skilled in the art will understand that the power values provided in the examples are only example values and that the power may be increased or decreased.

In implementations, one or more of the electric heating elements may be configured to deliver a decreasing heating power in a downstream direction along its length. In this way, a single electric heating element may provide an electric heating element power that reduces along the fluid flow path.

FIG. 9 illustrates schematically a way in which this can be done. The first electric heating element 102 is made up of a series of 20 electric heating element segments 105a, 105b, 105c, 105d, 105e, 105f, 105g, 105h, 105i, 105j, 105k, 105l, 105m, 105n, 105o, 105p, 105q, 105r, 105s, 105t. The 20 electric heating element segments 105a, 105b, 105c, 105d, 105e, 105f, 105g, 105h, 105i, 105j, 105k, 105l, 105m, 105n, 105o, 105p, 105q, 105r, 105s, 105t each have an electric heating element segment power. The sum of the electric heating element segment powers equals the electric heating element power, i.e. 6.6 kW for the first electric heating element 102. The electric heating element segment powers decrease progressively in the downstream direction along the fluid flow path 110, as shown in Table 1 below. In this example, the first electric heating element 102 has an active heated length of 1000 mm. Each one of the 20 electric heating element segments 105a, 105b, 105c, 105d, 105e, 105f, 105g, 105h, 105i, 105j, 105k, 105l, 105m, 105n, 105o, 105p, 105q, 105r, 105s, 105t has a length of 50 mm.

TABLE 1
Electric heating element segment powers for the first electric
heating element 102 of the water heater 100 shown in FIGS.
7, 8 and 9. The sum of the electric heating element segment
powers = an electric heating element power of 6.6 kW.

| Electric heating | Electric heating element |
|---|---|
| element segment | segment power in kW |
| 105a | 0.390 |
| 105b | 0.384 |
| 105c | 0.378 |
| 105d | 0.372 |
| 105e | 0.365 |
| 105f | 0.359 |
| 105g | 0.353 |
| 105h | 0.347 |
| 105i | 0.341 |
| 105j | 0.335 |
| 105k | 0.328 |
| 105l | 0.322 |
| 105m | 0.316 |
| 105n | 0.310 |
| 105o | 0.304 |
| 105p | 0.298 |
| 105q | 0.292 |
| 105r | 0.285 |
| 105s | 0.279 |
| 105t | 0.273 |

The second electric heating element 104 is made up of a series of 20 electric heating element segments 107a, 107b, 107c, 107d, 107e, 107f, 107g, 107h, 107i, 107j, 107k, 1071, 107m, 107n, 107o, 107p, 107q, 107r, 107s, 107t. The 20 electric heating element segments 107a, 107b, 107c, 107d, 107e, 107f, 107g, 107h, 107i, 107j, 107k, 1071, 107m, 107n, 107o, 107p, 107q, 107r, 107s, 107t each have an electric heating element segment power. The sum of the electric heating element segment powers equals the electric heating element power, i.e. 4.2 kW for the second electric heating element 104. The electric heating element segment powers decrease progressively in the downstream direction along the fluid flow path 110, as shown in Table 2 below. In this example, the second electric heating element 104 has an active heated length of 1000 mm. Each one of the 20 electric heating element segments 107a, 107b, 107c, 107d, 107e, 107f, 107g, 107h, 107i, 107j, 107k, 1071, 107m, 107n, 107o, 107p, 107q, 107r, 107s, 107t has a length of 50 mm.

TABLE 2
Electric heating element segment powers for the second electric
heating element 104 of the water heater 100 shown in FIGS.
7, 8 and 9. The sum of the electric heating element segment
powers = an electric heating element power of 4.2 kW.

| Electric heating | Electric heating element |
|---|---|
| element segment | segment power in kW |
| 107a | 0.267 |
| 107b | 0.261 |
| 107c | 0.255 |
| 107d | 0.248 |
| 107e | 0.242 |
| 107f | 0.236 |
| 107g | 0.230 |
| 107h | 0.224 |
| 107i | 0.218 |
| 107j | 0.212 |
| 107k | 0.205 |
| 107l | 0.199 |
| 107m | 0.193 |
| 107n | 0.187 |
| 107o | 0.181 |
| 107p | 0.175 |
| 107q | 0.168 |
| 107r | 0.162 |
| 107s | 0.156 |
| 107t | 0.150 |

In the embodiment shown in FIGS. 7 and 8, the internal filament is arranged such that the helical pitch increases sequentially in a downstream direction along each segment. In this way, the internal filament extending along each segment has a helical pitch greater than the section of internal filament extending along the segment immediately upstream.

In some implementations, rather than or as well as comprising a series of electric heater element segments, one or more of the electric heater elements may be configured such that the local electric heating element power varies continuously along at least a portion of the length of the electric heater element(s).

In some implementations, one or more of the electric heating elements may comprise an internal filament in the form of a coil having a helical pitch. The local electric heating element power may vary, e.g. increase or decrease, along at least a portion of the length of the electric heating element, due to changes in the helical pitch of the internal filament.

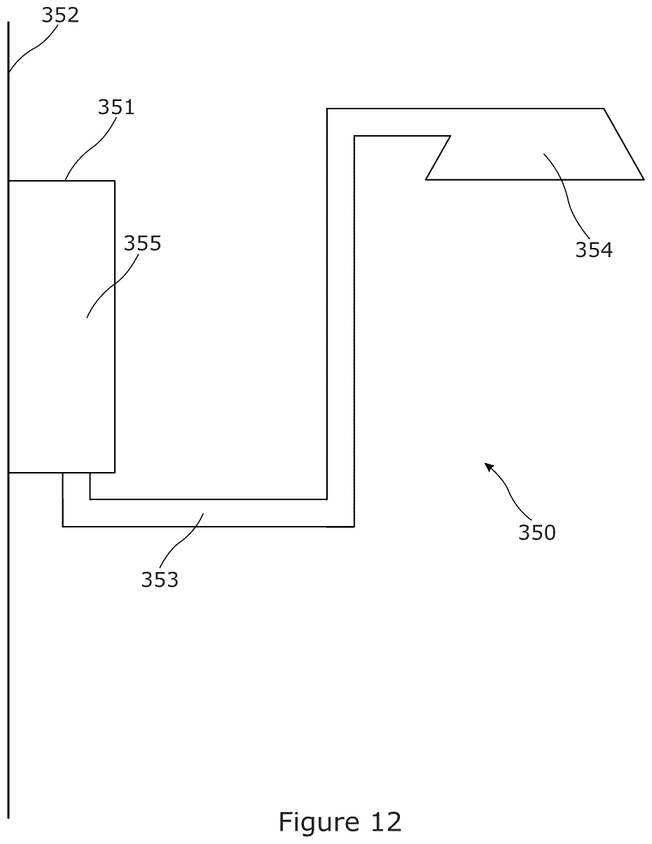

FIG. 12 shows schematically a plumbing system 350. An instantaneous water heater, illustrated as an electric shower unit 351 is mounted on a wall 352. The electric shower unit 351 comprises a casing 355 housing an instantaneous water heater comprising a heater tank such as the heater tank 1 or the heater tank 100 described above. The instantaneous water heater is connected to a water supply point (not shown) located within the wall 352. A hose 353 provides fluid communication from the instantaneous water heater to a spray head 354 located downstream thereof. A shower tray or bath tub (not shown) may be present to collect the water emitted from the spray head 354.

For convenience, the preceding examples have been discussed primarily in relation to electric showers. The skilled person will appreciate that other applications of the instantaneous water heater are possible. Similarly, the example embodiments are primarily discussed in terms of using water, but the skilled person will understand that the disclosure would equally apply to other fluids.

Employing a heater tank or an instantaneous water heater according to the present disclosure may enable a wider range of designs and configurations of instantaneous water heaters. For example, it may be possible to manufacture instantaneous water heaters having a relatively flat form factor as compared with traditional instantaneous water heaters. An instantaneous water heater having a relatively flat form factor may provide for new design possibilities, for example, for electric shower units. An instantaneous water heater having a relatively flat form factor may allow for more efficient use of space. For instance, an instantaneous water heater having a relatively flat form factor may be suited for deployment in a cavity in or behind a wall or a ceiling, e.g. as part of a built-in electric shower system.

Some examples of applications for a heater tank or an instantaneous water heater according to the present disclosure will now be described.

An instantaneous water heater according to the present disclosure may be utilised in an electric shower system comprising a waste water heat recovery system and the instantaneous water heater. The waste water heat recovery system may be configured to transfer heat from a waste water stream to a stream of cold water, e.g. from a mains supply, being conveyed to the instantaneous water heater.

This may increase the temperature of the water entering the instantaneous water heater. Consequently, the instantaneous water heater may not need to operate to provide as great a temperature increase, in order to provide an output water stream having a user-desired temperature for showering. This may mitigate the decrease in flow rate that can be experienced by users of electric showers in winter when the temperature of the UK mains supply can be 15° C. less than in summer (e.g. 5° C. in winter and 20° C. in summer). For example, in summer a 10.8 kW electric shower unit typically may provide a flow rate of around 8 litres per minute for a typical showering temperature of approximately 40° C., whereas, in the winter the flow rate can drop to around 4.5 litres per minute for a typical showering temperature of approximately 40° C. For example, in summer a 8.5 kW electric shower unit typically may provide a flow rate of around 6 litres per minute for a typical showering temperature of approximately 40° C., whereas, in the winter the flow rate can drop to around 3.5 litres per minute for a typical showering temperature of approximately 40° C. By utilising a waste water heat recovery system, the winter flow conditions can be improved by around 40%.

The relatively flat form factor of the heater tank disclosed herein may allow for a space efficient and/or convenient implementation of an electric shower system with an integrated waste water heat recovery system. For example, the heater tank shown in FIGS. 7, 8 and 9 may be relatively tall and suitable for use in a vertical orientation. Typically, the waste water heat recovery system is located at flow level. The electric shower system may be configured such that the heated stream of cold water may then enter the heater tank from floor level. The heater tank may be oriented vertically. Accordingly, the shower outlet and/or user controls may be present at a convenient and/or logical height.

Another example application for a heater tank according to the present disclosure is within a recirculating shower system. Generally, a recirculating shower user stored hot water to provide the hot top up (HTU) energy to maintain showering temperature that compensates for the energy lost to the surrounding air. For instance, the HTU water temperature may be higher than the selected showering temperature by approximately 10° C. and may be required to have a flow rate of around 2 litres per minute. An instantaneous water heater may be utilised to provide the HTU energy. A heater tank or an instantaneous water heater according to the present disclosure may be well suited to this purpose because the lower temperatures of the electric heating element(s) may reduce the build-up of limescale, as compared with conventional instantaneous water heater designs. Also, the relatively flat form factor of the heater tank disclosed herein may facilitate a relatively compact system design.

In another implementation of a recirculating shower system, a heater tank according to the present disclosure may be used to heat directly the recirculating flow.

Another example application for a heater tank according to the present disclosure is as part of an instantaneous water heater configured to supply a plurality of water delivery devices that utilise heated water. For instance, in a bathroom there may be a number of fluid delivery devices that utilise heated water such as a shower, wash basin taps and a bath fill. An instantaneous water heater comprising a heater tank according to the present disclosure may be configured to provide warm water to a wash basin tap and a shower. The low hot shot and low surface temperature characteristics of the heater tank may help to make it suitable for use in supplying hot water to a wash basin tap, even though the heater tank may be turned on and off repeatedly in such an application.

Another example application for a heater tank according to the present disclosure is to provide heated water to a wash basin tap, e.g. in a bathroom or a kitchen.

A kitchen tap may be configured such that it can deliver hotter water, e.g. water having a temperature of around 60° C., for pot washing, washing greasy utensils and hot water for floor cleaning etc. Higher temperature water dispensing can be achieved by controlling the water flow rate to the appropriate level.

The relatively flat form factor of the heater tank disclosed herein may allow, for example, the heater tank to be housed in a relatively small amount of space in an under-sink cupboard.

Another example application for a heater tank according to the present disclosure is to provide hot top up water heating for prolonged bathing, e.g. in a whirlpool bath. Water from the whirlpool bath may be conveyed to the heater tank inlet. The water from the whirlpool bath may typically have a temperature suitable for bathing such as from 35° C. to 40° C. The water may be heated by a few degrees centigrade as it passes along the fluid flow path to provide a heated bath water stream. The heated bath water stream exits the heater tank outlet and is conveyed back into the bath. In this way, the water in the whirlpool bath may be maintained at a preferred bathing temperature for an extended period of time. In this application, the heater tank may have a total heating power of around 3 kW. The low surface temperature of the heating element(s) may help to reduce the likelihood of the build-up of limescale or other deposits. Also, the relatively flat form factor of the heater tank disclosed herein may mean that the heater tank can be conveniently incorporated within the overall form factor of the whirlpool bath.

Another example application for a heater tank according to the present disclosure is to provide water heating in a washing machine or a dishwasher. Typically, the washing machine or the dishwasher may have a cold water feed only. The heater tank may be utilised to heat the cold water to a desired wash temperature. Additionally or alternatively, a heater tank according to the present disclosure may be configured to heat a recirculated stream of water to provide hot top up water to maintain the desired wash temperature.

Another example application for a heater tank according to the present disclosure is a whole building water heater, e.g. a whole house water heater. For such an application, the water heater may have a total heating power of from 20 kW to 30 kW or higher.

Another example application for a heater tank according to the present application is a bath fill. For such an application, the water heater may have a total heating power of from 20 kW to 30 kW or higher.

The heater tank may be employed to provide a bath fill for a walk-in bath. Additionally or alternatively, the heater tank may be employed to provide hot top up water heating for prolonged bathing in the walk-in bath, in which case the heater tank may be configured similarly to the whirlpool bath example application described above.

It will be understood that the invention is not limited to the embodiments above-described and various modifications and improvements can be made without departing from the concepts herein. Except where mutually exclusive, any of the features may be employed separately or in combination with any other features and the disclosure extends to and includes all combinations and sub-combinations of one or more features described herein.

1. A heater tank system comprising:
a heater tank having
a heater tank inlet,
a heater tank outlet, and
a fluid flow path from the heater tank inlet to the heater tank outlet;
one or more electric heating elements having an electric heating element power, the one or more electric heating elements heating fluid flowing, in use, along the fluid flow path;
wherein one or more of the electric heating elements extend along at least a portion of the fluid flow path and cause the fluid flowing, in use, along the fluid flow path to experience a reduction in a local electric heating element power as the fluid flows, in use, along the fluid flow path.

2. The heater tank system of claim 1, wherein the fluid flow path brings fluid into contact with a series of two of more electric heating elements, in which at least one of the electric heating elements has an electric heating element power that is less than that of the electric heating element immediately upstream thereof.

3. The heater tank system of claim 1, wherein one or more of the electric heating elements comprises a series of a plurality of electric heating element segments, wherein at least one of the electric heating element segments has an electric heating element segment power that is less than that of the electric heating element segment immediately upstream thereof.

4. The heater tank system of claim 1, wherein the local electric heating element power varies continuously along at least a portion of the length of the electric heater element(s).

5. The heater tank system of claim 1, wherein one or more of the electric heating elements comprises an internal filament in the form of a coil having a helical pitch.

6. The heater tank system of claim 5, wherein the local electric heating element power varies along at least a portion of the length of the electric heating element, due to changes in the helical pitch of the internal filament.

7. The heater tank system of claim 1, wherein the fluid flow path passes through one or more heater tubes.

8. The heater tank system of claim 7, wherein the fluid flow path passes through a plurality of heater tubes fluidly connected in flow series.

9. The heater tank system of claim 8 comprising up to 10 heater tubes fluidly connected in flow series and forming at least a portion of the fluid flow path.

10. The heater tank system of claim 8, wherein two or more of the heater tubes are arranged in parallel with each other at least in part.

11. The heater tank system of claim 8, wherein two or more of the heater tubes are integrally formed with each other.

12. The heater tank system of claim 7, wherein at least one electric heating element is disposed at least partially within each heater tube.

13. An instantaneous water heater comprising:
an inlet and an outlet;
a heater tank having
a heater tank inlet in fluid communication with the inlet,
a heater tank outlet in fluid communication with the outlet, and
a fluid flow path from the heater tank inlet to the heater tank outlet;
one or more electric heating elements having an electric heating element power, the one or more electric heating elements heating fluid flowing, in use, along the fluid flow path;
wherein one or more of the electric heating elements extend along at least a portion of the fluid flow path and cause the fluid flowing, in use, along the fluid flow path to experience a reduction in a local electric heating element power as the fluid flows, in use, along the fluid flow path.

14. The instantaneous water heater of claim 13, wherein the heater tank is surrounded at least partially by a casing.

15. The instantaneous water heater of claim 14, wherein the casing surrounds at least partially further components of the instantaneous water heater.

16. The instantaneous water heater of claim 14, wherein the instantaneous water heater includes control circuitry configured to control operation of the heater tank.

17. The instantaneous water heater according to claim 16 comprising a user input device operably connected to the control circuitry configured to control operation of the heater tank.

18. A plumbing system comprising:
an ablutionary fitting;
a heater tank having
a heater tank inlet in fluid communication with the inlet,
a heater tank outlet in fluid communication with the outlet, and
a fluid flow path from the heater tank inlet to the heater tank outlet, the outlet providing fluid to the ablutionary fitting directly or through plumbing;
one or more electric heating elements having an electric heating element power, the one or more electric heating elements heating fluid flowing, in use, along the fluid flow path;
wherein one or more of the electric heating elements extend along at least a portion of the fluid flow path and cause the fluid flowing, in use, along the fluid flow path to experience a reduction in a local electric heating element power as the fluid flows, in use, along the fluid flow path.

19. The plumbing system of claim 18, wherein the plumbing system is an electric shower in which a showerhead is the ablutionary fitting that receives fluid from the heater tank.

20. The plumping system of claim 19, wherein the plumbing system includes control circuitry configured to control operation of the heater tank.
